(19) United States
(12) Patent Application Publication
(10) Pub. No.: US 2012/0258385 A1
(43) Pub. Date: Oct. 11, 2012

(54) METHOD AND APPARATUS FOR MEASURING VOLUME OF LIQUID AND FUEL CELL SYSTEM

(76) Inventors: Lei HU, Yongin-si (KR); Hye-jung CHO, Anyang-si (KR); Young-jae KIM, Seoul (KR); Young-seung NA, Yongin-si (KR)

(21) Appl. No.: 13/443,208

(22) Filed: Apr. 10, 2012

(30) Foreign Application Priority Data
Apr. 11, 2011 (KR) 10-2011-0033374

(51) Int. Cl. G01F 23/26; H01M 8/04; G06F 19/00

(52) U.S. Cl. 429/515; 702/55

(57) ABSTRACT

The volume of liquid that remains in a liquid storage is calculated by measuring capacitances between several pairs of metal plates attached to each of several corresponding faces of the liquid storage and by combining liquid volumes corresponding to the capacitance based on the current position of the liquid storage. Such a method of measuring the volume of liquid can be used to measure the amount of fuel that remains in a fuel cell system.

### BACKGROUND

1. Field

The present disclosure relates to methods and apparatuses for measuring a volume of liquid, and more particularly, to methods and apparatuses for measuring the amount of fuel that remains in a fuel cell system.

2. Description of the Related Art

Fuel cells have drawn attention, together with solar cells and the like, as an eco-friendly replacement energy technology for generating electrical energy from material that is abundant on the earth, such as hydrogen, or the like. Fuel, water, air, and the like may be supplied to fuel cells so as to generate power by using fuel cell systems.

### SUMMARY

According to an embodiment, there is provided a method of measuring a volume of liquid, the method including receiving a first capacitance value representing a first capacitance between first metal plates attached to a liquid storage and a second capacitance value representing a second capacitance between second metal plates attached to the liquid storage, obtaining a first liquid volume value corresponding to the first capacitance value and a second liquid volume value corresponding to the second capacitance value, and calculating a volume of liquid that remains in the liquid storage by combining a plurality of liquid volume values including the first liquid volume value and the second liquid volume value.

The calculating of the volume of liquid may include calculating a first weighting factor with respect to the first liquid volume value and a second weighting factor with respect to the second liquid volume value based on a current position of the liquid storage, and calculating the volume of liquid by combining the plurality of liquid volume values including the first liquid volume value to which the calculated first weighting factor is applied and the second liquid volume value to which the second calculated weighting factor is applied.

The calculating of the volume of liquid may include adding together the plurality of liquid volume values including the first liquid volume value to which the calculated first weighting factor is applied and the second liquid volume value to which the second calculated weighting factor is applied.

The calculating of the volume of liquid may include calculating the current position of the liquid storage from a first gradient of the first metal plates having the first capacitance and a second gradient of the second metal plates having the second capacitance.

The first metal plates having the first capacitance may be attached to each of first corresponding faces of the liquid storage. The second metal plates having the second capacitance may be attached to each of second corresponding faces of the liquid storage.

The calculating of the volume of liquid may include calculating a first weighting factor with respect to the first liquid volume value based on a gradient formed by the first metal plates attached to each of the first corresponding faces and calculating a second weighting factor with respect to the second liquid volume value based on a gradient formed by the second metal plates attached to each of the second corresponding faces.

The first liquid volume value and the second liquid volume value may be obtained based on a change in the first capacitance and the second capacitance due to a change in an amount of liquid that remains in the liquid storage.

The first liquid volume value and the second liquid volume value may be obtained from a database providing values representing changes in the first capacitance and the second capacitance due to changes in an amount of liquid that remains in the liquid storage.

The first liquid volume value and the second liquid volume value may be obtained from a function indicating changes in the first capacitance and the second capacitance due to changes in an amount of liquid that remains in the liquid storage.

According to an embodiment, there is provided a computer-readable recording medium having recorded thereon a program for executing a method of measuring a volume of liquid, the method including receiving a first capacitance value representing a first capacitance between first metal plates attached to a liquid storage and a second capacitance value representing a second capacitance between second metal plates attached to the liquid storage, obtaining a first liquid volume value corresponding to the first capacitance value and a second liquid volume value corresponding to the second capacitance value, and calculating a volume of liquid that remains in the liquid storage by combining a plurality of liquid volume values including the first liquid volume value and the second liquid volume value.

According to an embodiment, there is provided an apparatus for measuring a volume of liquid, the apparatus including a first pair of metal plates attached to a liquid storage for measurement of a first capacitance, a second pair of metal plates attached to the liquid storage for measurement of a second capacitance, and a processor that calculates a volume of liquid that remains in the liquid storage based on the first capacitance and the second capacitance.

The liquid storage may include a housing having an insulation property. The first pair of metal plates for measurement of the first capacitance may be attached to first corresponding faces among internal faces of the housing. The second pair of metal plates for measurement of the second capacitance may be attached to second corresponding faces among the internal faces of the housing.

The first corresponding faces and the second corresponding faces may be disposed vertically.

At least one of the first corresponding faces and the second corresponding faces may be curved faces.

A third pair of metal plates may be attached to the liquid storage for measurement of a third capacitance.

The liquid storage may further include a housing having an insulation property, and a pouch in which liquid is stored, the pouch being located in the housing, and the pouch having elasticity.

A first surface of the pouch may adjoin and may be fixed to one metal plate among the first pair of metal plates and second pair of metal plates and a second surface of the pouch may not be fixed to any of the metal plates among the first pair of metal plates and the second pair of metal plates.

A size of the pouch may be greater than an internal size of the housing.

The apparatus may further include a position sensor detecting a current position of the liquid storage. The position sensor may be attached to a face of the liquid storage and may detect the current position of the liquid storage by detecting a gradient formed by the face to which the position sensor is attached with respect to a reference face.

The processor may measure an amount of liquid that remains in the liquid storage by combining liquid volume values corresponding to the first capacitance and the second capacitance based on the current position of the liquid storage.

According to an embodiment, there is provided a fuel cell system including a first pair of metal plates attached to a fuel storage for measurement of first capacitance, a second pair of metal plates attached to the liquid storage for measurement of second capacitance, and a controller that calculates a volume of fuel that remains in the fuel storage based on the first capacitance and the second capacitance.

The fuel storage may include a housing having an insulation property. The first pair of metal plates for measurement of the first capacitance may be attached to first corresponding faces among internal faces of the housing. The second pair of metal plates for measurement of the second capacitance may be attached to second corresponding faces among the internal faces of the housing.

The fuel storage may include a housing having an insulation property, and a pouch in which fuel is stored, the pouch being located in the housing and having elasticity. Part of a surface of the pouch may adjoin part of the metal plates and may be fixed to the part of the metal plates.

The fuel cell system may further include a position sensor detecting a current position of the liquid storage. The controller may measure an amount of fuel that remains in the fuel storage by combining fuel volume values corresponding to the first capacitance and the second capacitance based on the current position of the fuel storage.

### BRIEF DESCRIPTION OF THE DRAWINGS

Features will become apparent to those of ordinary skill in the art by describing in detail exemplary embodiments with reference to the attached drawings in which:

FIG. 1 schematically illustrates a structure of a fuel cell system according to an embodiment;

FIG. 2 illustrates a structure of an apparatus for measuring a volume of liquid according to an embodiment;

FIGS. 3A and 3B illustrate a case where a pouch is installed in a liquid storage illustrated in FIG. 2;

FIG. 4 illustrates several positions (a), (b), and (c) in which the liquid storage of FIG. 2 may be disposed;

FIG. 5 illustrates a graph of a change in measured values of capacitance of a channel A according to a change in the volume of liquid disposed in three positions illustrated in FIG. 4 in which the liquid storage of FIG. 2 is disposed;

FIG. 6 illustrates a graph of a change in measured values of capacitance of a channel B according to a change in the volume of liquid disposed in the three positions illustrated in FIG. 4 in which the liquid storage of FIG. 2 is disposed;

FIG. 7 illustrates a graph of a change in measured values of the capacitance of channel A according to a change in the volume of liquid including bubbles disposed in the three positions illustrated in FIG. 4 in which the liquid storage of FIG. 2 is disposed;

FIG. 8 illustrates a graph of a change in the measured values of the capacitance of channel B according to a change in the volume of liquid including bubbles disposed in the three positions illustrated in FIG. 4 in which the liquid storage of FIG. 2 is disposed;

FIG. 9 illustrates a flowchart illustrating a method of measuring a volume of liquid according to an embodiment; and

FIGS. 10A and 10B illustrate structures of an apparatus for measuring a volume of liquid according to other embodiments.

### DETAILED DESCRIPTION

Korean Patent Application No. 10-2011-0033374, filed on Apr. 11, 2011, in the Korean Intellectual Property Office, and entitled: “Method and Apparatus for Measuring Volume of Liquid and Fuel Cell System,” is incorporated by reference herein in its entirety.

Example embodiments will now be described more fully hereinafter with reference to the accompanying drawings; however, they may be embodied in different forms and should not be construed as limited to the embodiments set forth herein. In the drawing figures, the dimensions of layers and regions may be exaggerated for clarity of illustration. Like reference numerals refer to like elements throughout.

The features of the following embodiments are associated with a new method of measuring a volume of liquid that remains in a liquid storage. Since the new method of measuring the volume of liquid that remains in the liquid storage represented in the following embodiments may be mainly used as a way to measure the amount of fuel that remains in a fuel cell system, the fuel cell system will now be described so as to describe the new method's efficiency and effects of measuring the volume of liquid that remains in the liquid storage.

The fuel cell system generally includes a fuel cell that generates power by using fuel, balance of plant (BOP) elements, which are peripheral devices of the fuel cell for supplying fuel, water, air, or the like to the fuel cell, and a converter for converting power output from the fuel cell and supplying the power to load of the fuel cell. The features of the following embodiments are associated with detection of the amount of remaining fuel. Accordingly, a detailed description of a stack, a converter, or the like, which constitute the fuel cell except for the BOP elements will not be repeated here so as not to obscure the features of the present embodiments. In general, the fuel cell may be designed in the form of a stack in which a plurality of cells are combined in series or in parallel to one another according to power required by a load of the fuel cell. Hereinafter, the term “fuel cell” will be used generally to refer to stacks in which one cell is present or a plurality of cells are combined with each other.

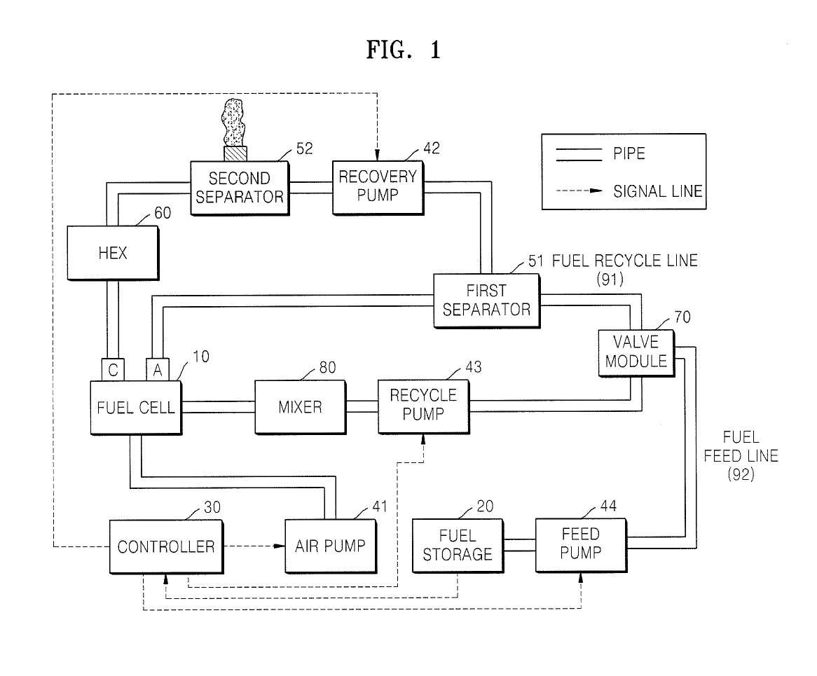

FIG. 1 illustrates a structure of a fuel cell system according to an embodiment. Referring to FIG. 1, the fuel cell system according to the current embodiment includes a fuel cell 10, a fuel storage 20, a controller 30, an air pump 41, a water recovery pump 42, a recycle pump 43, a feed pump 44, a first separator 51, a second separator 52, a heat exchanger 60, a valve module 70, and a mixer 80. As described above, the above elements for supplying materials required for generation of power of the fuel cell 10, i.e., fuel, water, air, or the like, are referred to as BOP elements. As illustrated in FIG. 1, some pipes for connecting the above elements are installed among the BOP elements.

In addition, there may be other devices than the elements of FIG. 1 in the fuel cell system illustrated in FIG. 1. For example, a heat exchanger other than the heat exchanger 60 of FIG. 1 may be installed in a position different from a position in which the heat exchanger 60 is installed, for example, between the recycle pump 43 and the mixer 80, so as to recover heat generated in the fuel cell system. In addition, a concentration sensor for measuring concentration of the fuel supplied to the fuel cell 10 may be installed in a pipe installed between the fuel cell 10 and the mixer 80, and a thermistor may be installed on the surface of the fuel cell 10 so as to measure reaction heat generated in the fuel cell 10.

The fuel cell 10 is a power generation device that generates direct current (DC) power by converting chemical energy of the fuel stored in the fuel storage 20 directly into electrical energy by using an electrochemical reaction. Examples of the fuel cell 10 include a solid oxide fuel cell (SOFC), a polymer electrolyte membrane fuel cell (PEMFC), a direct methanol fuel cell (DMFC), and the like. In particular, the fuel cell system including BOP elements for operating a DMFC is illustrated in FIG. 1. Technical features that will be described below may be applied to various kinds of fuel cells.

In the DMFC, methanol and water directly react with each other in an anode of the fuel cell 10 so that hydrogen ions and electrons may be generated. The DMFC is different from an indirect methanol fuel cell, in which methanol is reformed to increase the concentration of hydrogen. The DMFC does not require the process of reforming methanol, and thus, may be miniaturized. In addition, since methanol is in a liquid state at room temperature, the fuel may be easily stored and moved. Thus, the DMFC may be used in a portable fuel cell system.

In general, a reaction indicated by CH₃OH+H₂O->6H⁺+6e⁻+CO₂ occurs in the anode of the DMFC, and a reaction indicated by 3/2O₂+6H⁺+6e⁻->3H₂O occurs in a cathode of the DMFC. Protons H⁺ are transferred via a proton exchange membrane in a fuel cell, and electrons are transferred from the anode to the cathode of the fuel cell via an external circuit. Power is generated by performing the above process. A catalyst exists in the DMFC so as to allow a smooth reaction in the DMFC. Generally, the catalyst may be formed of platinum and may be deteriorated when the temperature in the above-described reaction process is too high. Thus, pure methanol is typically not supplied to the fuel cell 10. Instead, methanol diluted with an appropriate amount of water, i.e., a methanol aqueous solution with appropriate concentration may be supplied to the fuel cell 10. Hereinafter, any type of methanol aqueous solution supplied to the anode of the fuel cell 10 and methanol stored in the fuel storage 20 may be referred to as fuel.

An appropriate amount of methanol, water, and air may be supplied to the fuel cell 10 so as to prevent deterioration of the fuel cell 10 and allow a smooth reaction in the fuel cell 10. The controller 30 controls the air pump 41, the feed pump 44, the recycle pump 43, and the water recovery pump 42 so as to adjust the amount of fuel, water, air supplied to the fuel cell 10. As illustrated in FIG. 1, the controller 30 may measure the amount of fuel that remains in the fuel storage 20 by using capacitances between at least two pairs of metal plates attached to the fuel storage 20. Also, the controller 30 may control the air pump 41, the feed pump 44, the recycle pump 43, and the water recovery pump 42 based on the measured amount of remaining fuel. Measuring of the amount of remaining fuel will be described in more detail below. The fuel cell 10 generates power by using fuel of an appropriate concentration supplied to the anode from the mixer 80. When the fuel cell 10 generates power, carbon dioxide (CO₂) that is a by-product of the reaction process, unreacted fuel, or the like may be discharged from the anode of the fuel cell 10, and water that is a by-product of the reaction process may be discharged from the cathode of the fuel cell 10.

The first separator 51 separates methanol and water from the by-product discharged from the anode of the fuel cell 10, the unreacted fuel, or the like, thereby recovering methanol and water. The by-product discharged from the cathode of the fuel cell 10 includes moisture in the form of vapor as high-temperature fluid generated due to reaction heat in the fuel cell 10. The by-product is cooled by a heat exchange process of the heat exchanger 60 while passing through the heat exchanger 60, and some water is recovered in the process. The second separator 52 separates water from the by-product cooled in this manner, thereby recovering water and discharging CO₂ that is the remaining by-product after the recovery process is performed, or the like, to the outside. The first separator 51 and the second separator 52 may separate methanol and water from the by-product, the unreacted fuel, or the like, discharged from the fuel cell 10, by using centrifugal separation or the like. The water recovery pump 42 pumps water recovered by the second separator 52 and discharges water toward the first separator 51. Thus, fuel with low concentration in which methanol recovered by the first separator 51 and water recovered by the first separator 51 and the second separator 52 are mixed, may be discharged from the first separator 51.

The fuel storage 20 may be shaped as a vessel in which the fuel is stored, such as a cylinder, box, and the like. The fuel storage 20 may be shaped as a form in which the fuel may be refilled. In addition, the fuel storage 20 may be shaped to be attached to or detached from the fuel cell system of FIG. 1. A general fuel storage that may be attached to or detached from a fuel cell system may also be referred to as a cartridge. Undiluted fuel with high concentration, for example, 100% methanol, may be stored in the fuel storage 20. As in the current embodiment, at least two pairs of metal plates may be attached to the fuel storage 20 so as to measure capacitance required for measuring the amount of fuel that remains in the fuel storage 20.

The valve module 70 may be inserted in a position in which a fuel recycle line 91 and a fuel feed line 92 are connected to each other. The valve module 70 controls the flow of the low-concentration fuel recycled from the fuel cell 10 to the fuel storage 20 via the fuel recycle line 91 and the flow of the high-concentration fuel recycled from the fuel storage 20 to the fuel cell 10 via the fuel feed line 92. In this regard, the term “fuel recycle line 91” may refer to pipes forming the path where the unreacted fuel discharged from the fuel cell 10 flows in the fuel cell 10 again, and the term “fuel feed line 92” may refer to pipes forming the path where new fuel is supplied from the fuel storage 20 to the fuel cell 10.

The recycle pump 43 pumps at least one of the low-concentration fuel transported from the valve module 70 via the fuel recycle line 91 and the high-concentration fuel transported from the valve module 70 via the fuel feed line 92 based on the flow of the fuel controlled by the valve module 70, thereby discharging the pumped fuel to the mixer 80. The mixer 80 mixes the low-concentration fuel and the high-concentration fuel discharged from the recycle pump 43 so that appropriate concentration of fuel generated by the mixing operation may be supplied to the fuel cell 10.

Generally, the fuel cell 10 reacts normally at a predetermined temperature or higher and generates normal power. Thus, when the temperature of the fuel cell 10 is over a predetermined level after the fuel cell system of FIG. 1 has started, a normal operation in which power output from the fuel cell 10 is supplied to a load of the fuel cell 10, may be performed. The fuel may be continuously supplied to the fuel cell 10 until the temperature of the fuel cell 10 reaches a predetermined level. When the remaining amount of fuel stored in the fuel storage 20 is not enough to raise the temperature of the fuel cell 10 to the predetermined level, the fuel cell system of FIG. 1 may not be started. In addition, when the fuel stored in the fuel storage 20 is exhausted, the reaction of the fuel cell 10 cannot be normally performed and thus, the operation of the fuel cell system may be stopped before the fuel is exhausted.

For the above reasons, the fuel cell system may include an apparatus for measuring the remaining amount of fuel stored in the fuel storage 20. The fuel cell system may be started or stopped by controlling the air pump 41, the feed pump 44, the recycle pump 43, and the recovery pump 42 based on a measured value of the amount of remaining fuel. In the fuel cell system illustrated in FIG. 1, elements for measuring the remaining amount of the fuel stored in the fuel storage 20 may be installed at the controller 30 and the fuel storage 20. In addition, the fuel cell system may inform a user of the remaining operating time of the fuel cell system due to the remaining amount of the fuel based on the amount of remaining fuel measured in this manner or may output a message indicating to refill the fuel or to replace a fuel cartridge to the fuel storage 20.

As described above, the DMFC that may be miniaturized may be mainly used in a portable fuel cell system. In the portable fuel cell system, a predetermined position of the fuel storage 20 may not be maintained due to movement caused by being carried by a user. In addition, when the user refills fuel in the fuel storage 20 or replaces a fuel cartridge, air may flow into the fuel storage 20 due to the user's carelessness or usage environment, and bubbles may be generated in the fuel storage 20 due to air in the fuel storage 20. Hereinafter, technical features for precisely measuring the remaining amount of the fuel stored in the fuel storage 20 regardless of a change in the position of the fuel storage 20 or bubbles generated in the fuel storage 20 will be described.

The desirability of the following technical features has been suggested from the fuel feed environment of the fuel cell system. However, the technical features may also be used in devices other than the fuel cell system, in which the remaining amount of a liquid is to be detected. Thus, an apparatus and a method of measuring the remaining amount of liquid by generalizing fuel as the liquid will now be described in detail.

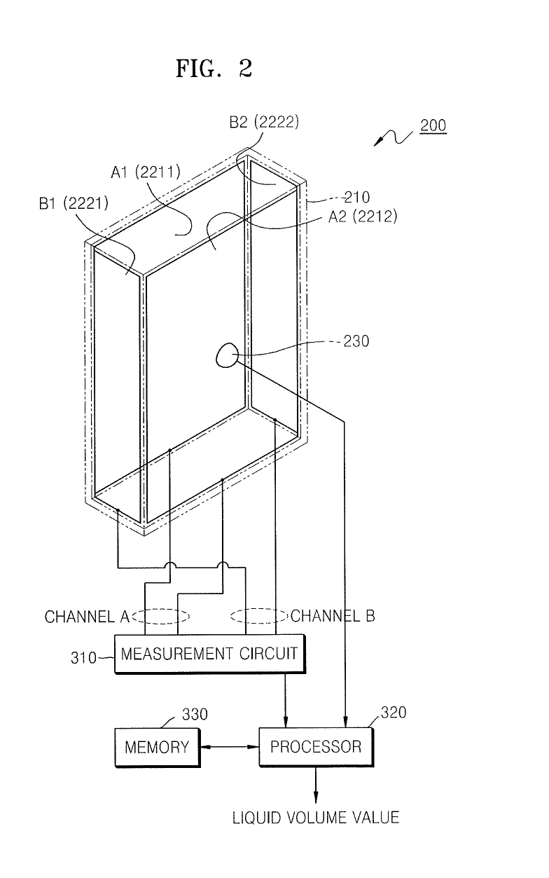

FIG. 2 illustrates a structure of an apparatus for measuring the volume of liquid according to an embodiment. Referring to FIG. 2, the apparatus for measuring the volume of liquid according to the current embodiment includes a liquid storage 200, a measurement circuit 310, a position sensor 230, a processor 320, and a memory 330. When the apparatus for measuring the volume of liquid that will be described below is applied to the fuel cell system of FIG. 1, the above elements may be installed at the fuel storage 20 and at the controller 30 illustrated in FIG. 1. For example, the liquid storage 200 and the position sensor 230 may be installed at the fuel storage 20, and the measurement circuit 310, the processor 320, and the memory 330 may be installed at the controller 30.

The liquid storage 200 may be formed as a vessel in which the liquid is stored, such as a cylinder, box, and the like. As illustrated in FIG. 2, the liquid storage 200 may be a vessel having at least four internal faces whereby at least two pairs of conductive metal plates 2211, 2212 and 2221, 2222 may be attached to the four internal faces. Referring to FIG. 2, the liquid storage 200 includes a housing 210 having an insulation property, a pair of metal plates 2211 and 2212 attached to corresponding faces that are parallel to each other, from internal faces of the housing 210, and another one pair of metal plates 2221 and 2222 attached to the other corresponding faces that are parallel to each other, of the housing 210. Each metal plate of the pairs of the metal plates 2211 and 2212 or 2221 and 2222 may have the same or similar sizes to each other so that capacitance therebetween may be constant regardless of the position of the liquid storage 200. In other words, capacitances between the metal plates 2211 and 2212 or 2221 and 2222 having the same or similar sizes may be determined based on a material inserted therebetween.

As illustrated in FIG. 2, the area of the metal plates 2211 and 2212 or 2221 and 2222 may be smaller than the area of the internal faces of the housing 210 for insulation between the metal plates 2211, 2212, 2221, and 2222. However, the area of the metal plates 2211 and 2212 or 2221 and 2222 may have the same size as the area of the internal faces of the housing 210, if desired. Capacitances between the metal plates 2211 and 2212 or 2221 and 2222 may be precisely measured as the area of the metal plates 2211 and 2212 or 2221 and 2222 increases in the housing 210. Thus, the area of each of the metal plates the metal plates 2211 and 2212 or 2221 and 2222 may be set to be as large as possible within the range where the neighboring metal plates 2211, 2212, 2221, and 2222 may be insulated from one another.

The measurement circuit 310 electrifies the metal plates 2211 and 2212 via electric wires connected to the pair of metal plates 2211 and 2212, thereby measuring the capacitances between the metal plates 2211 and 2212. In addition, the measurement circuit 310 electrifies the metal plates 2221 and 2222 via electric wires connected to the pair of metal plates 2221 and 2222, thereby measuring the capacitances between the metal plates 2221 and 2222. Hereinafter, the capacitance between the metal plates 2211 and 2212 is referred to as the capacitance of “channel A” and the capacitance between the metal plates 2221 and 2222 is referred to as the capacitance of “channel B.” There may be several methods of measuring capacitances between parallel metal plates as illustrated in FIG. 2 that are well-known. The capacitances between parallel metal plates illustrated in FIG. 2 may be calculated by using Equation 1. In Equation 1, ∈ represents a dielectric constant of the material inserted between the metal plates 2211 and 2212 or 2221 and 2222, i.e., a dielectric constant of a liquid, and S represents the area of the metal plates 2211 and 2212 or 2221 and 2222, and d represents a distance between the metal plates 2211 and 2212 or 2221 and 2222.

$$C = ∈ \frac{S}{d} \qquad [ Equation 1 ]$$

Since the area of the pair of metal plates 2211 and 2212 or 2221 and 2222 illustrated in FIG. 2 and the distance between the pair of metal plates 2211 and 2212 or 2221 and 2222 illustrated in FIG. 2 are fixed, the capacitances between the pair of metal plates 2211 and 2212 or 2221 and 2222 illustrated in FIG. 2 are changed due to the dielectric constant of the material inserted therebetween, for example, dielectric constants of liquid and air. Thus, when the liquid storage 200 of FIG. 2 is installed in a portable device, such as a portable fuel cell system, the position of the liquid storage 200 may be changed according to a method of using the portable device, the environment in which it is used, or the like. In this regard, the dielectric constant of the material inserted between the pair of metal plates 2211 and 2212 or 2221 and 2222 illustrated in FIG. 2 may be changed due to the amount and a gradient of liquid that exists therebetween.

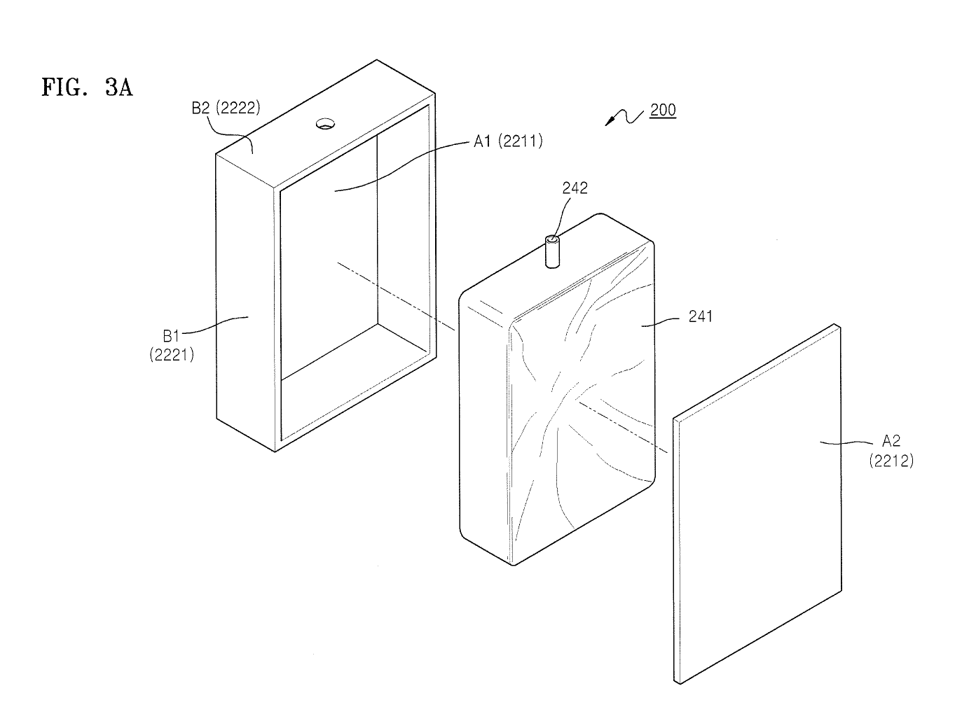

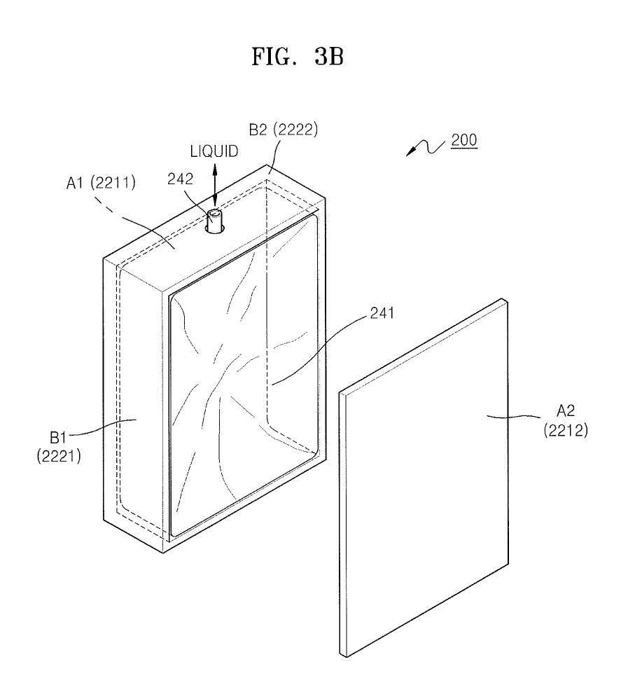

FIGS. 3A and 3B illustrate a case where a pouch 241 is installed in the liquid storage 200 illustrated in FIG. 2. The housing 210 of the liquid storage 200 may be formed of a non-flexible insulating material, such as plastic having rigidity, or the like, so as to protect material inside the housing 210. In general, an internal storage space of the liquid storage 200 may have a structure for preventing outflow of liquid (for example, may be in a sealed state). When the internal storage space of the liquid storage 200 has the structure for preventing outflow of liquid and liquid is discharged from the liquid storage 200 or is injected into the liquid storage 200, the internal storage space of the liquid storage 200 may be contracted or expanded based on a change in the volume of liquid stored in the liquid storage 200. However, when the housing 210 of the liquid storage 200 is formed of a material having rigidity, as illustrated in FIGS. 3A and 3B, the housing 210 may not be easily deformed due to the change in the volume of liquid in the liquid storage 200. Thus, the pouch 241 may be disposed in the housing 210, as illustrated in FIGS. 3A and 3B, or the housing 210 may have a structure in which gas, such as air, an inert gas, or the like, may enter and exit based on the change in the volume of liquid in the liquid storage 200.

As illustrated in FIGS. 3A and 3B, when the pouch 241 is disposed in the housing 210, the pouch 241 may be formed of an elastic material. The size of the pouch 241 may be the same as or greater than the internal size of the housing 210. Liquid is stored in the pouch 241. In addition, the pouch 241 may be formed of a non-elastic material shaped as a thin layer having a greater area than the internal size of the housing 210. For example, the pouch 241 may be formed of a non-elastic material shaped as a thin layer having the area at which all faces of the pouch 241 may be closely adhered to one another, so that bubbles may not be generated in a non-liquid state.

The pouch 241 may be formed of an elastic waterproof or impermeable material, such as vinyl, rubber, or the like, in a similar form to the form of the internal space of the housing 210. Liquid may be injected into or discharged from the pouch 241 via an opening 242 of the pouch 241. Thus, the pouch 241 may be contracted or expanded. A gap or hole through which air enters or exits, may be formed in the housing 210 for smooth expansion and contraction of the pouch 241. The housing 210 may have one opening 242 or a plurality of openings (not shown), as illustrated in FIGS. 3A and 3B. If air enters or exits based on the change in the volume of liquid in the liquid storage 200 so that the internal storage space of the liquid storage 200 is not contracted or expanded, the pouch 241 may be omitted. For example, if the housing 210 is formed of material through which air is transmitted and liquid is not transmitted, the pouch 241 may be omitted.

Referring to FIGS. 3A and 3B, part of the surface of the pouch 241 may adjoin three metal plates 2211, 2221, and 2222 among four metal plates in the housing 210 and may be fixed thereto, and the other part of the surface of the pouch 241 may not adjoin these plates and may not be fixed thereto. When the pouch 241 is formed of an elastic material, the pouch 241 may be attached to three metal plates 2211, 2221, and 2222 so as to fix the shape of the pouch 241, or the pouch 241 may be unattached with respect to the metal plate 2212 so as to ease expansion and contraction of the pouch 241. When liquid in the pouch 241 is exhausted, the pouch 241 may be fully contracted and compressed on the surface of the three metal plates 2211, 2221, and 2222, and when liquid flows in the pouch 241 and the pouch 241 is fully expanded, the pouch 241 may have the shape of an internal space of the liquid storage 200. For example, the pouch 241 may have a rectangular box-shaped internal space as illustrated in FIGS. 3A and 3B.

As illustrated in FIGS. 3A and 3B, in each of the pair of metal plates 2221 and 2222 that correspond to channel B, all faces at both sides of the housing 210 always adjoin the pouch 241, and the whole of one face of the metal plate 2221 and one face of the metal plate 2222 are always attached to the pouch 241. On the other hand, in each of the other one pair of metal plates 2211 and 2212 that correspond to channel A, only the whole of one face of one metal plate 2211 is always attached to one part of the pouch 241, and a contact face between one face of the other one metal plate 2212 and part of the pouch 241 is determined based on the volume of liquid in the pouch 241. When liquid is fully filled in the pouch 241, the pouch 241 and all the faces of the metal plate 2212 may adjoin each other. However, as the volume of liquid filled in the pouch 241 is decreased, the contact area between the pouch 241 and the metal plate 2212 is gradually decreased. If the volume of liquid filled in the pouch 241 is decreased to a threshold value, the pouch 241 and the metal plate 2212 may be fully separated from each other. A structural difference between channel A and channel B is represented as a characteristic difference in capacitances between channel A and channel B.

The position sensor 230 detects the current position of the liquid storage 200. For example, the position sensor 230 detects a gradient formed by the face to which the position sensor 230 is attached, with respect to a reference face, thereby detecting the current position of the liquid storage 200. The position sensor 230 may be implemented as an acceleration sensor or the like. In FIG. 2, the position sensor 230 may be attached to the external face of the housing 210 to which the metal plate 2212 is attached. The position of the position sensor 230 is not limited to the external face of the housing 210, and the position sensor 230 may be attached to several positions other than the external face of the housing 210, if necessary.

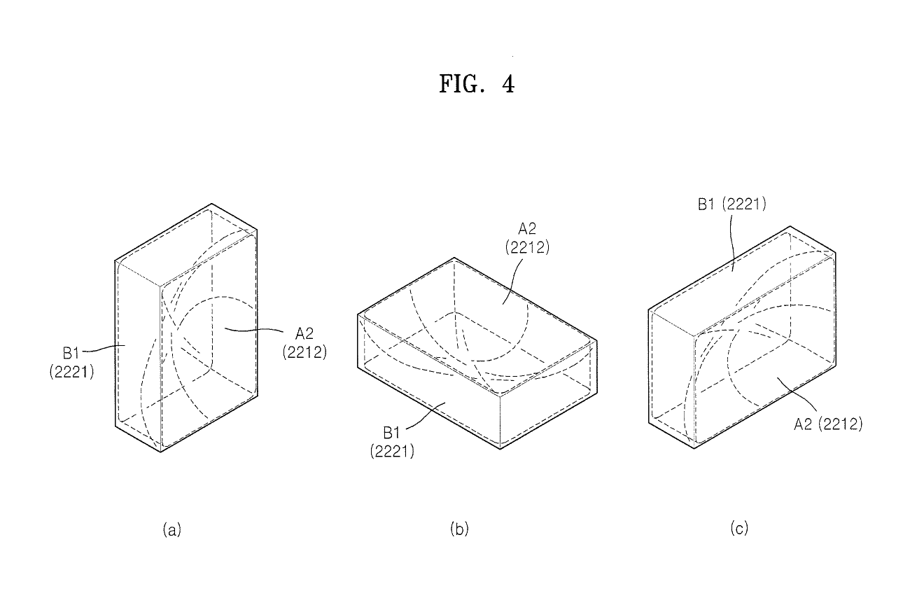

FIG. 4 illustrates several positions in which the liquid storage 200 of FIG. 2 is disposed. Position (a) of FIG. 4 represents a standing position in which all of the four metal plates 2211, 2212, 2221, and 2222 are standing. Position (b) of FIG. 4 represents a face position in which a pair of metal plates 2211 and 2212 that correspond to channel A, among the four metal plates 2211, 2212, 2221, and 2222 are laid flat and the other one pair of metal plates 2221 and 2222 that correspond to channel B are standing. Position (c) of FIG. 4 represents a side position in which a pair of metal plates 2211 and 2212 that correspond to channel A, among the four metal plates 2211, 2212, 2221, and 2222 stand and the other one pair of metal plates 2221 and 2222 that correspond to channel B are laid flat. Since a pair of metal plates 2211 and 2212 or 2221 and 2222 that correspond to each of the channels A and B are symmetrical with each other, which one of the pair of metal plates 2211 and 2212 or 2221 and 2222 is disposed upwards or downwards, does not affect capacitance therebetween.

In general, when a reference face is set on the position sensor 230, the position sensor 230 outputs a value that corresponds to 0 degrees when the position sensor 230 is disposed on the reference face. The reference face of the position sensor 230 may be set with a factor for manufacturing the position sensor 230 or may be input to the position sensor 230 by the user. When the reference face of the position sensor 230 is set to a face to which the position sensor 230 is attached in a standing position among three positions of the liquid storage 200 illustrated in FIG. 4, i.e., in a direction of gravity, a value detected by the magnetic sensor 230 in the standing position may be 0 degrees. In the lying flat position, the direction of the face to which the position sensor 230 is attached forms 90 degrees with the direction of gravity. In such a case, a value detected by the position sensor 230 may be 90 degrees. In addition, in the side position, the direction of the face to which the position sensor 230 is attached may be the direction of gravity, in such a case, a value detected by the position sensor 230 may be 0 degrees.

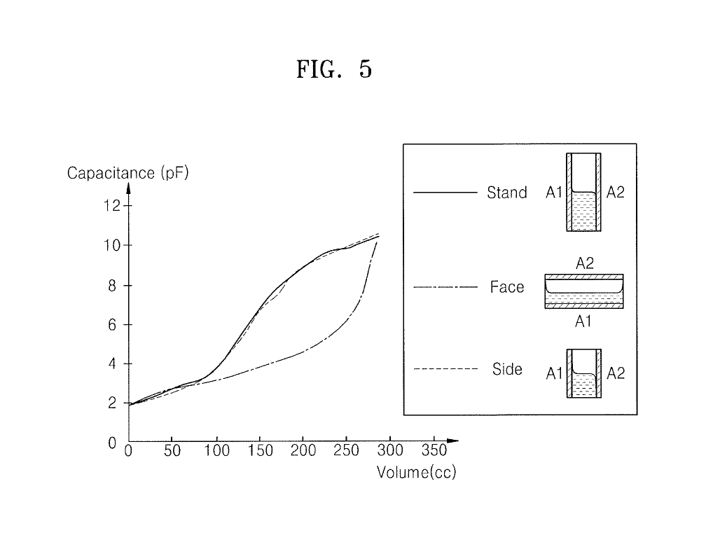

FIG. 5 is a graph of a change in measured values of capacitance of a channel A according to a change in the volume of liquid disposed in the three positions illustrated in FIG. 4 in which the liquid storage 200 of FIG. 2 is disposed. In the graph of FIG. 5, the volume of methanol that remains in the liquid storage 200 in each of the three positions of the liquid storage 200 of FIG. 4, i.e., the volume of methanol stored in the pouch 241, is changed at regular intervals, and the capacitance of channel A is measured, and then measured values of capacitance with respect to the volume of methanol are indicated on an xy-plane and are connected to one another. The measured values illustrated in FIG. 5 are just examples of measured values of capacitance in a particular experimental environment, and it will be understood by one of ordinary skill in the art that different values may be measured according to a change in the environment where capacitance is measured.

As described above, capacitances between the pair of metal plates 2211 and 2212 or 2221 and 2222 illustrated in FIG. 2 are changed by only the material inserted therebetween. Generally, the dielectric constant of air is about 1, and the dielectric constant of methanol is about 30. According to Equation 1, the capacitances between the pair of metal plates 2211 and 2212 or 2221 and 2222 illustrated in FIG. 2 in a case where only methanol exists between the metal plates 2211, 2212, 2221, and 2222 illustrated in FIG. 2 are about 30 times higher than a case where only air exists therebetween. Thus, when methanol contacts only one side of the pair of metal plates 2211 and 2212 or 2221 and 2222 and air contacts the other side thereof, the capability to store charges between the metal plates is greatly lowered due to the blocking effect of air.

When methanol does not remain in the pouch 241 or a very small amount of methanol remains therein, the pouch 241 is fully contracted, and even when the position of the liquid storage 200 is changed, the shape of the pouch 241 may not be changed. When methanol is fully filled in the pouch 241, the pouch 241 is fully expanded, and similarly, even when the position of the liquid storage 200 is changed, the shape of the pouch 241 may not be changed. In the above cases, even when the position of the liquid storage 200 is changed, the shape of the material inserted between the metal plates 2211 and 2212 may not be changed. Referring to FIG. 5, when the volume of methanol stored in the pouch 241 is less than a lower limit value or greater than an upper limit value, almost the same capacitance of channel A in all three positions of the liquid storage 200 of FIG. 4 may be detected.

On the right side of FIG. 5, when methanol is injected into the pouch 241 by about half of the whole storage volume of the liquid storage 200, the cross-sectional shape of the medium inserted between the metal plates 2211 and 2212 that correspond to channel A in the three positions of the liquid storage 200 of FIG. 4 is shown. In this case, the pouch 241 may have a shape that corresponds to a middle state between the case where the pouch 241 is fully contracted and the case where the pouch 241 is fully expanded. Referring to FIG. 5, in the standing position and the side position among the three positions of the liquid storage 200 of FIG. 4, methanol contacts both sides of both metal plates 2211 and 2212 that correspond to channel A with respect to the change in the volume of methanol in the liquid storage 200 so that capacitances between the metal plates 2211 and 2212 with respect to the change in the volume of methanol that remains in the pouch 241 are changed almost linearly in whole sections of the standing position and the side position. However, in the face position, the pouch 241 and the metal plate 2212 are separated from each other, and methanol contacts only the metal plate 2211, and air contacts the metal plate 2212. In other words, in a middle section of the face position, the capability to store charges between the metal plates 2211 and 2212 is greatly lowered. Thus, in the face position, capacitances between the metal plates 2211 and 2212 with respect to the change in the volume of methanol that remains in the pouch 241 are changed non-linearly in a middle section of the face position.

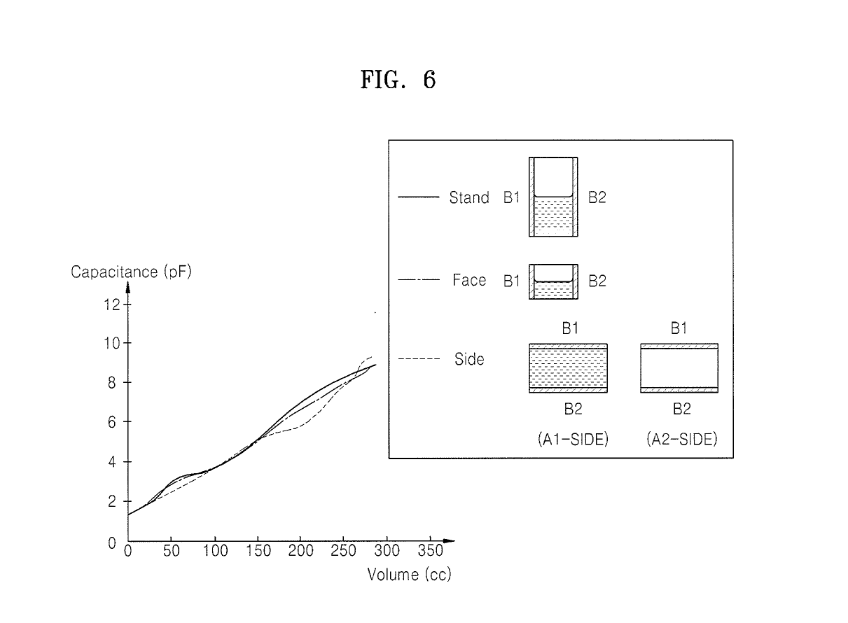

FIG. 6 is a graph of a change in measured values of capacitance of channel B according to a change in the volume of liquid disposed in three positions of the liquid storage 200 illustrated in FIG. 4 in which the liquid storage 200 of FIG. 2 is disposed. In particular, in the graph of FIG. 6, the volume of methanol that remains in the liquid storage 200 in each of the three positions of the liquid storage 200 of FIG. 4, i.e., the volume of methanol stored in the pouch 241, is changed at regular intervals, and the capacitance of channel B is measured, and then measured values of capacitance with respect to the volume of methanol are indicated on the xy-plane and are connected to one another. The measured values illustrated in FIG. 6 are just examples of measured values of capacitance in a particular experimental environment, and it will be understood by one of ordinary skill in the art that different values may be measured according to a change in the environment where capacitance is measured.

When methanol does not remain in the pouch 241 or a very small amount of methanol remains therein, the pouch 241 is fully contracted, and even when the position of the liquid storage 200 is changed, the shape of the pouch 241 may not be changed. When methanol is fully filled in the pouch 241, the pouch 241 is fully expanded, and similarly, even when the position of the liquid storage 200 is changed, the shape of the pouch 241 may not be changed. In the above cases, even when the position of the liquid storage 200 is changed, the shape of the material inserted between the metal plates 2221 and 2222 may not be changed. Referring to FIG. 6, when the volume of methanol stored in the pouch 241 is less than a lower limit value or greater than an upper limit value, almost the same capacitance of channel B in all three positions of the liquid storage 200 of FIG. 4 may be detected.

On the right side of FIG. 6, when methanol is injected into the pouch 241 by an amount that is about half of the whole storage volume of the liquid storage 200, the cross-sectional shape of the material inserted between the metal plates 2221 and 2222 that correspond to channel B in the three positions of the liquid storage 200 of FIG. 4 is shown. In this case, the pouch 241 may have a shape that corresponds to a middle state between the case where the pouch 241 is fully contracted and the case where the pouch 241 is fully expanded. Referring to FIG. 6, in all three positions of the liquid storage 200 of FIG. 4, methanol contacts both sides of both metal plates 2221 and 2222 that correspond to channel B with respect to the change in the volume of methanol in the liquid storage 200 so that capacitances between the metal plates 2221 and 2222 with respect to the change in the volume of liquid that remains in the pouch 241 are changed almost linearly in whole sections of the x-axis for all three positions. Since the pouch 241 always contacts both metal plates 2221 and 2222 and is fixed therein, methanol may contact both sides of both metal plates 2221 and 2222 that correspond to channel B regardless of the change in the position of the liquid storage 200.

A first A1-side cross-sectional shape of the medium in the side position of FIG. 6 indicates, as a cutting plane of the pouch 241 which is cut close to the metal plate 2221, that methanol contacts both sides of both metal plates 2221 and 2222. In addition, a second A2-side cross-sectional shape of the medium in the side position of FIG. 6 indicates, as a cutting plane of the pouch 241 which is cut close to the metal plate 2222, that air contacts both sides of both metal plates 2221 and 2222. In this way, since the pouch 241 and the metal plate 2222 are separated from each other, a cross-sectional shape of the medium in the side position indicates that the amount of methanol is reduced from the metal plate 2221 to the metal plate 2222 and the ratio of air with respect to methanol is increased. Since methanol contacts both sides of both metal plates 2221 and 2222 that correspond to channel B on the side of the metal plate 2221 so that capacitances between the metal plates 2221 and 2222 are changed almost linearly but the blocking effect of air is increased compared to other positions, and linear characteristics of the capacitances between the metal plates 2221 and 2222 are slightly lowered.

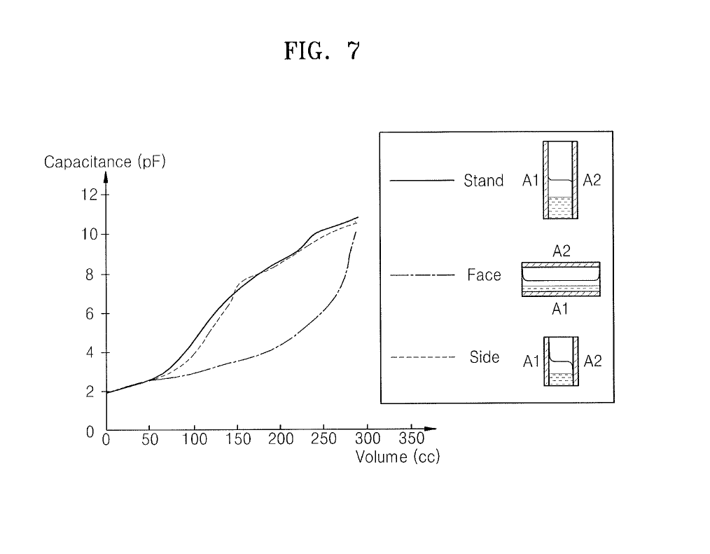

FIG. 7 is a graph of a change in measured values of capacitance of channel A according to a change in the volume of liquid including bubbles disposed in three positions illustrated in FIG. 4 in which the liquid storage 200 of FIG. 2 is disposed. In particular, in the graph of FIG. 7, a predetermined amount of air is injected into the liquid storage 200, i.e., into the pouch 241, in each of the three positions of the liquid storage 200 of FIG. 4, and the volume of methanol stored in the pouch 241 is changed at regular intervals, and the capacitance of channel A is measured, and then measured values of capacitance with respect to the volume of methanol are indicated on the xy-plane and are connected to one another. The measured values illustrated in FIG. 7 are just examples of measured values of capacitance in a particular experimental environment, and it will be understood by one of ordinary skill in the art that different values may be measured according to a change in the environment where capacitance is measured.

When methanol does not remain in the pouch 241 or a very small amount of methanol remains therein, the pouch 241 may be fully contracted, and a small amount of methanol and air or air may exist alone between the metal plates 2211 and 2212 that correspond to channel A. In this case, even when the position of the liquid storage 200 is changed, the shape of the material inserted between the metal plates 2211 and 2212 is not changed. Referring to FIG. 7, when the volume of methanol stored in the pouch 241 is less than a lower limit value or greater than an upper limit value, almost the same capacitance of channel A in all of the three positions of the liquid storage 200 of FIG. 4 may be detected. On the other hand, when methanol is injected into the pouch 241 until the pouch 241 is fully expanded, even when the position of the liquid storage 200 is changed, the shape of the pouch 241 is not changed. However, unlike in FIG. 5, since previously-injected air and methanol coexist in the pouch 241, movement between light air and heavy methanol in the pouch 241 occurs according to a change in the position of the liquid storage 200. Referring to FIG. 7, compared to the graph of FIG. 5, a smaller amount of methanol that corresponds to the volume of previously-injected air is injected into the pouch 241, and even when the volume of methanol stored in the pouch 241 is greater than an upper limit value, unlike in the graph of FIG. 5, similar capacitance of channel A in three positions of the liquid storage 200 of FIG. 4 may not be detected.

On the right side of FIG. 7, when air and methanol are injected by an amount that is about half of the whole storage volume of the liquid storage 200, the cross-sectional shape of the material inserted between the metal plates 2211 and 2212 that correspond to channel A in the three positions of the liquid storage 200 of FIG. 4 is shown. In this case, the pouch 241 may have a shape that corresponds to a middle state between the case where the pouch 241 is fully contracted and the case where the pouch 241 is fully expanded. Referring to FIG. 7, in the standing position and the side position among three positions of the liquid storage 200 of FIG. 4, methanol contacts both sides of both metal plates 2211 and 2212 that correspond to channel A with respect to the change in the volume of methanol in the liquid storage 200 so that capacitances between the metal plates 2211 and 2212 with respect to the change in the volume of liquid that remains in the pouch 241 are changed almost linearly in whole sections of the x-axis for the standing position and the side position. However, in the face position, the pouch 241 and the metal plate 2212 are separated from each other so that methanol contacts only the metal plate 2211 and air contacts the metal plate 2212. In other words, in a middle section of the face position, the capacity to store charges between the metal plates 2211 and 2212 is greatly lowered. Thus, in the middle section of the face position, the capacitances between the metal plates 2211 and 2212 are changed non-linearly with respect to a change in the volume of methanol that remains in the pouch 241.

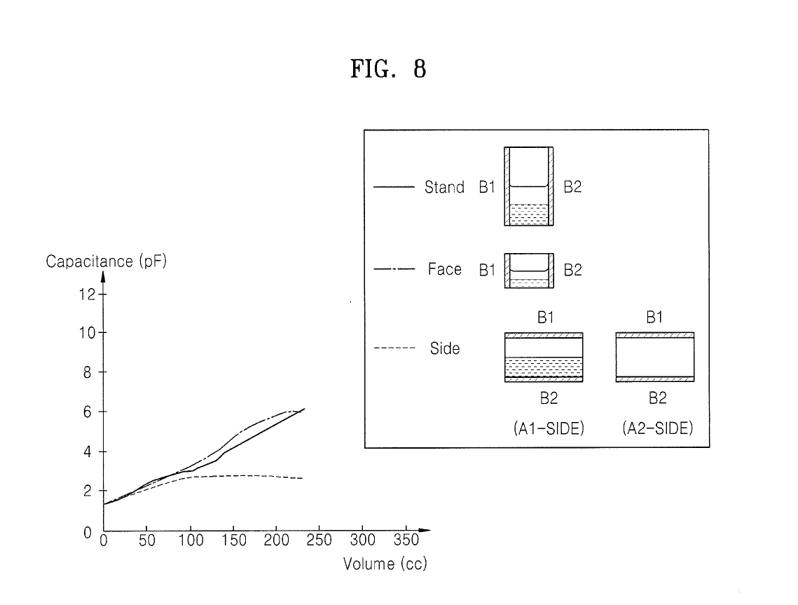

FIG. 8 is a graph of a change in measured values of capacitance of channel B according to a change in the volume of liquid including bubbles disposed in three positions illustrated in FIG. 4 in which the liquid storage 200 of FIG. 2 is disposed.

In the graph of FIG. 8, a predetermined amount of air is injected into the liquid storage 200, i.e., into the pouch 241, in each of the three positions of the liquid storage 200 of FIG. 4, and the volume of methanol stored in the pouch 241 is changed at regular intervals, and the capacitance of channel B is measured, and then measured values of capacitance with respect to the volume of methanol are indicated on the xy-plane and are connected to one another. The measured values illustrated in FIG. 8 are just examples of measured values of capacitance in a particular experimental environment, and it will be understood by one of ordinary skill in the art that different values may be measured according to a change in the environment where capacitance is measured.

When methanol does not remain in the pouch 241 or a very small amount of methanol remains therein, the pouch 241 is fully contracted, and a small amount of methanol and air or air alone exist between the metal plates 2221 and 2222 that correspond to channel B. In this case, even when the position of the liquid storage 200 is changed, the shape of the material inserted between the metal plates 2221 and 2222 is not changed. Referring to FIG. 8, when the volume of methanol stored in the pouch 241 is less than a lower limit value, almost the same capacitance of channel B in all of the three positions of the liquid storage 200 of FIG. 4 may be detected. On the other hand, when methanol is injected into the pouch 241 until the pouch 241 is fully expanded, even when the position of the liquid storage 200 is changed, the shape of the pouch 241 is not changed. However, unlike in FIG. 6, since previously-injected air and methanol coexist in the pouch 241, movement between light air and heavy methanol in the pouch 241 may occur according to a change in the position of the liquid storage 200. Referring to FIG. 8, compared to the graph of FIG. 6, a smaller amount of methanol that corresponds to the volume of previously-injected air is injected into the pouch 241, and even when the volume of methanol stored in the pouch 241 is greater than an upper limit value, unlike in the graph of FIG. 6, similar capacitance of channel B in three positions of the liquid storage 200 of FIG. 4 may not be detected

On the right side of FIG. 8, when air and methanol are injected by an amount that is about half of the whole storage volume of the liquid storage 200, the cross-sectional shape of the material inserted between the metal plates 2221 and 2222 that correspond to channel B in the three positions of the liquid storage 200 of FIG. 4 is shown. In this case, the pouch 241 may have a shape that corresponds to a middle state between the case where the pouch 241 is fully contracted and the case where the pouch 241 is fully expanded. Referring to FIG. 8, in the standing position and the face position among three positions of the liquid storage 200 of FIG. 4, methanol contacts both sides of both metal plates 2221 and 2222 that correspond to channel B with respect to the change in the volume of methanol in the liquid storage 200 so that capacitances between the metal plates 2221 and 2222 with respect to the change in the volume of liquid that remains in the pouch 241 are changed almost linearly in whole sections of the x-axis for the standing position and the face position. Since the pouch 241 contacts both metal plates 2221 and 2222 that correspond to channel B and are fixed therein, methanol always contacts both sides of both metal plates 2221 and 2222 that correspond to channel B regardless of the change in the position of the liquid storage 200.

On the other hand, a first cross-sectional shape of the medium in the side position of FIG. 8 indicates that, with respect to a cutting plane of the pouch 241 that is cut close to the metal plate 2211, methanol contacts only the metal plates 2221 and air contacts only the metal plate 2222. Unlike the first cross-sectional shape of the medium in the side position of FIG. 6, air contacts the metal plate 2222 due to previously-injected air. In addition, a second cross-sectional shape of the medium in the side position of FIG. 8 indicates that, with respect to a cutting plane of the pouch 241 which is cut close to the metal plate 2212, air contacts both sides of both metal plates 2221 and 2222. In this way, since the pouch 241 and the metal plate 2212 may be separated from each other and a predetermined amount of air is injected into the pouch 241, air always contacts the metal plate 2221. Thus, in almost whole sections of the side position except for a section in which the pouch 241 is fully contracted, the capacitances between the metal plates 2221 and 2222 are changed non-linearly with respect to a change in the volume of methanol that remains in the pouch 241.

The result of observing changes of measured values of each channel according to a change in the volume of liquid illustrated in FIGS. 5 through 8 is as follows. First, when methanol does not remain in the pouch 241 or a very small amount of methanol remains in the pouch 241, the pouch 241 is fully contracted, and even when the position of the liquid storage 200 is changed, the shape of the pouch 241 is not changed. In this regard, capacitance between the metal plates 2211 and 2212 that corresponds to channel A and capacitance between the metal plates 2221 and 2222 that corresponds to channel B are precisely measured. In general, measuring of the remaining amount of liquid is more significant when the volume of liquid that remains in the liquid storage 200 is small.

In all whole sections of the standing position among three positions of the liquid storage 200 of FIG. 4, the capacitance between the metal plates 2211 and 2212 that corresponds to channel A and the capacitance between the metal plates 2221 and 2222 that corresponds to channel B may be precisely measured. In the face position, the capacitance between the metal plates 2221 and 2222 that corresponds to channel B have more linear characteristics than in the capacitance between the metal plates 2211 and 2212 that corresponds to channel A. Lastly, in the side position, the capacitance between the metal plates 2211 and 2212 that corresponds to channel A is less affected by bubbles, such as air injected into the liquid storage 200, than the capacitance between the metal plates 2221 and 2222 that corresponds to channel B. As described above, such a difference between characteristics of channel A and channel B may occur due to a change in the material inserted between the pair of metal plates 2211 and 2212 or 2221 and 2222 generated when liquid in the liquid storage 200 or air moves according to the change in the position of the liquid storage 200.

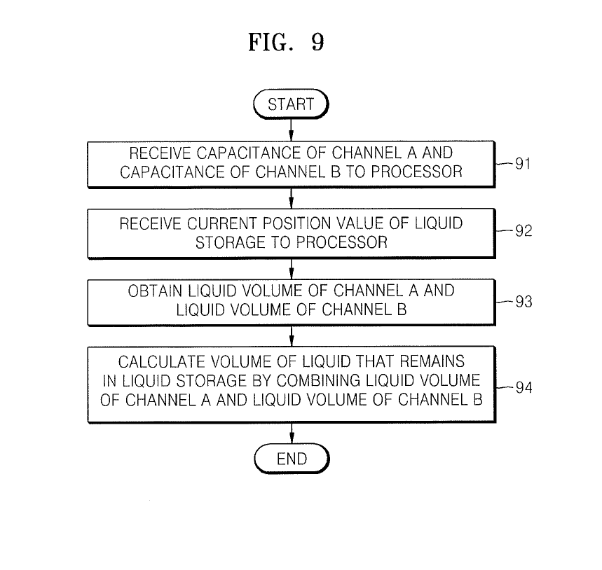

Referring to FIG. 2, in order to precisely measure the volume of the fuel stored in the liquid storage 200 in any of three positions of the liquid storage 200, the processor 320 calculates the volume of liquid stored in the liquid storage 200 by finding a combination of liquid volumes values corresponding to the capacitance of channel A and the capacitance of channel B that are most appropriate to the current position of the liquid storage 200 based on the current position of the liquid storage 200 detected by the position sensor 230. For example, the processor 320 may increase a weighting factor of the liquid volume corresponding to the capacitance of a channel for providing a more precise value of capacitances. The detailed operation of the processor 320 will now be described with reference to FIG. 9.

FIG. 9 is a flowchart illustrating a method of measuring the volume of liquid according to an embodiment. Referring to FIG. 9, the method of measuring the volume of liquid according to the current embodiment may include operations processed according to time. Thus, although omitted, the description of the apparatus for measuring the volume of liquid illustrated in FIG. 2 may also be applied to the method of FIG. 9. When the following method is applied to the fuel cell system of FIG. 1, the following operations may be performed by the controller 30 of the fuel cell system of FIG. 1. The controller 30 includes the function of the processor 320 of FIG. 2 and may also perform operations of controlling the BOP as well as the following operations.

In operation 91, a capacitance value representing the capacitance between the metal plates 2211 and 2212 that corresponds to channel A and a capacitance value representing the capacitance between the metal plates 2221 and 2222 that corresponds to channel B are input to the processor 210 by the measurement circuit 310. In operation 92, a value indicating the current position of the liquid storage 200 is input to the processor 320 by the position sensor 230. For example, the value indicating the current position of the liquid storage 200 may be a gradient of the parallel metal plates 2211 and 2212 that correspond to channel A, based on the direction of gravity, i.e., a gradient of the face of the housing 210 to which the parallel metal plates 2211 and 2212 are attached.

In operation 93, the processor 320 obtains a liquid volume value corresponding to the capacitance value of channel A and a liquid volume value corresponding to the capacitance value of channel B that are input in operation 91, based on a change in the capacitance of channel A and a change in the capacitance of channel B due to a change in the remaining amount of liquid in the liquid storage 200. For example, the processor 320 may read the liquid volume value corresponding to the capacitance value of channel A and the liquid volume value corresponding to the capacitance value of channel B that are input in operation 91, from a database established with change values of the capacitance of channel A and change values of the capacitance of channel B due to the change in the remaining amount of liquid in the liquid storage 200, thereby obtaining the liquid volume value corresponding to the capacitance of channel A and the liquid volume value corresponding to the capacitance of channel B. Alternatively, the processor 320 may input the capacitance value of channel A and the capacitance value of channel B that are input in operation 91 into a function indicating the change in the capacitance of channel A and the change in the capacitance of channel B due to the change in the remaining amount of liquid in the liquid storage 200, thereby obtaining the liquid volume value corresponding to the capacitance of channel A and the liquid volume value corresponding to the capacitance of channel B.

As illustrated in FIGS. 5 and 6, the capacitance of channel A and the capacitance of channel B according to the liquid volumes may be measured by changing the volume of liquid stored in the liquid storage 200 in predetermined units in the several positions of the liquid storage 200 of FIG. 4. The measured capacitance may be established in a table form in which the capacitance of channel A and the capacitance of channel B are mapped to the volume of liquid changed in predetermined units. Since the capacitance values stored in the database are discrete values, the processor 320 may predict liquid volumes that correspond to the capacitance of channel A and the capacitance of channel B that are input in operation 91, from liquid volume values corresponding to the capacitance that is most similar to the capacitance of channel A and the capacitance of channel B when the capacitance value of channel A and the capacitance value of channel B that input in operation 91 have not been found from the database. For example, the processor 320 may calculate the liquid volume value corresponding to the capacitance of channel A from an average between liquid volume values corresponding to two capacitances in which the capacitance value of channel A that is input in operation 91 exists in a middle position of the two capacitances.

Alternatively, the measured capacitance may be expressed as a function indicating the change in the capacitance of channel A and a function indicating the change in the capacitance of channel B due to the change in the remaining amount of liquid in the liquid storage 200. The measured values illustrated in FIGS. 7 and 8 are obtained in a state where bubbles exist in the liquid storage 200. Such bubbles are usually generated due to the user's carelessness or characteristics of the usage environment and thus, the volume of the bubbles cannot be predicted. Thus, the measured values of FIGS. 7 and 8 are values that are variable according to the volume of the bubbles that exist in the liquid storage 200. In the current embodiment, the database may be established or a function may be determined by using values measured in an optimal state where there are no bubbles.

In operation 94, the processor 320 may calculate the volume of liquid that remains in the liquid storage 200 by combining the liquid volume value corresponding to channel A and the liquid volume value corresponding to channel B obtained in operation 93, based on the current position of the liquid storage 200 detected by the position sensor 230. More specifically, the processor 320 may calculate a weighting factor with respect to the liquid volume value corresponding to channel A and a weighting factor with respect to the liquid volume value corresponding to channel B based on the current position of the liquid storage 200 detected by the position sensor 230 and may calculate the volume of liquid that remains in the liquid storage 200 by combining the liquid volume value corresponding to channel A and the liquid volume value corresponding to channel B to which the weighting factor is respectively applied. The weighting factor of the liquid volume corresponding to channel A and the weighting factor of the liquid volume corresponding to channel B may be calculated from a gradient value of the metal plates 2211 and 2212 that correspond to channel A and a gradient value of the metal plates 2221 and 2222 that correspond to channel B.

For example, the processor 320 may calculate the volume of liquid that remains in the liquid storage 200 by multiplying a liquid volume value V1 corresponding to channel A by a weighting factor k1, a liquid volume value V2 corresponding to channel B by a weighting factor k2, and by adding up the liquid volume value V1 corresponding to channel A by which the weighting factor k1 is multiplied and the liquid volume value V2 corresponding to channel B by which the weighting factor k2 is multiplied by using Equation 2 below. In Equation 2, θ₁ represents the gradient of the metal plates 2211 and 2212 that correspond to channel A with respect to a vertical face, and θ₂ represents the gradient of the metal plates 2221 and 2222 that correspond to channel B with respect to a vertical face.

$$Volume = k 1 * V 1 + k 2 * V 2 ( k 1 = \frac{COS {θ}_{1}}{COS {θ}_{1} + COS {θ}_{2}} , k 2 = 1 - k 1 ) \qquad [ Equation 2 ]$$

In the standing position among three positions of the liquid storage 200 of FIG. 4, all of θ₁ and θ₂ are 0 degrees. In other words, in the standing position, the weighting factor k1 of the liquid volume value V1 corresponding to channel A is 0.5, and the weighting factor k2 of the liquid volume value V2 corresponding to channel B is 0.5. Thus, the processor 320 may calculate the volume of liquid that remains in the liquid storage 200 by adding up the liquid volume value corresponding to channel A and the liquid volume value corresponding to channel B by which the same weighting factor is multiplied. The capacitance between the metal plates 2211 and 2212 that corresponds to channel A and the capacitance between the metal plates 2221 and 2222 may be precisely measured in whole sections of the standing position.

In the face position among three positions of the liquid storage 200 of FIG. 4, θ₁ is 90 degrees, and θ₂ is 0 degrees. In other words, in the face position, the weighting factor k1 of the liquid volume value V1 corresponding to channel A is 0, and the weighting factor k2 of the liquid volume value V2 corresponding to channel B is 1. Thus, the processor 320 may calculate the volume of liquid that remains in the liquid storage 200 by using only the liquid volume value corresponding to channel B. Accordingly, in the face position, the capacitance between the metal plates 2221 and 2222 that corresponds to channel B may have more linear characteristics than in the capacitance between the metal plates 2211 and 2212 that corresponds to channel A.

In the side position among three positions of the liquid storage 200 of FIG. 4, θ₁ is 0 degrees, and θ₂ is 90 degrees. In other words, in the side position, the weighting factor k1 of the liquid volume value V1 corresponding to channel A is 1, and the weighting factor k2 of the liquid volume value V2 corresponding to channel B is 0. Thus, the processor 320 may calculate the volume of liquid that remains in the liquid storage 200 by using only the liquid volume value of channel A. Accordingly, in the side position, the capacitance between the metal plates 2211 and 2212 that corresponds to channel A are less affected by bubbles, such as air injected into the liquid storage 200, than the capacitance between the metal plates 2221 and 2222 that corresponds to channel B.

According to Equation 2, the processor 320 may increase or decrease the weighting factor k1 of the liquid volume value V1 corresponding to channel A and decrease or increase the weighting factor k2 of the liquid volume value V2 corresponding to channel B according to a change in the gradient θ₁ of the metal plates 2211 and 2212 and the gradient O₂ of the metal plates 2221 and 2222, with are continuously changed as the position of the liquid storage 200 is changed from one position to another. For example, as the position of the liquid storage 200 is changed from the face position to the side position, the weighting factor k1 of the liquid volume value V1 corresponding to channel A may increase, and the weighting factor k2 of the liquid volume value V2 corresponding to channel B may decrease. In this way, the processor 320 may adjust the weighting factor k1 of the liquid volume value V1 corresponding to channel A and the weighting factor k2 of the liquid volume value V2 corresponding to channel B in consideration of the gradient θ₁ of the metal plates 2211 and 2212 and the gradient θ₂ of the metal plates 2221 and 2222, which are continuously changed and thus may calculate the volume of liquid that remains in the liquid storage 200 precisely in any of the three positions of the liquid storage 200.

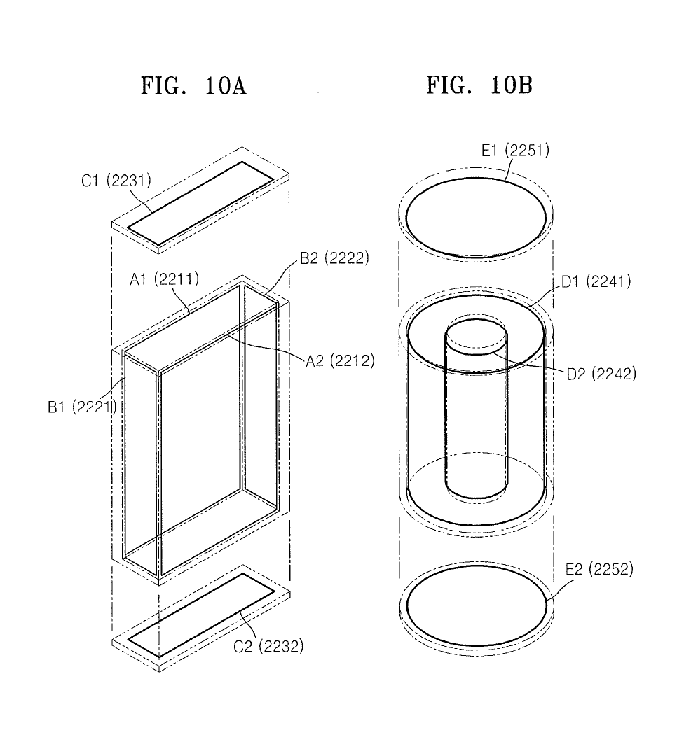

FIGS. 10A and 10B illustrate structures of an apparatus for measuring the volume of liquid according to other embodiments. As described above, the apparatus for measuring the volume of liquid of FIG. 2 may measure the volume of liquid that remains in the liquid storage 200 by using the capacitances of two channels A and B from the two pairs of metal plates 2211 and 2212 and 2221 and 2222. The apparatus for measuring the volume of liquid of FIG. 2 may measure the remaining amount of liquid precisely in any of the three positions of the liquid storage 200 by giving a higher weight to the capacitance of a channel, of two channels A and B, that provides a more precise value for the remaining amount of liquid to the current position of the liquid storage 200. Thus, when capacitances of more channels can be obtained from the liquid storage 200, a more precise liquid remaining amount with respect to the current position of the liquid storage 200 may be calculated. FIG. 10A shows an embodiment in which an additional pair of metal plates 2231 and 2232 is attached to top and bottom surfaces of the liquid storage 200 so as to add capacitance of a channel C, i.e., a third capacitance in addition to the capacitance of channel A and the capacitance of channel B of the apparatus for measuring the volume of liquid of FIG. 2.

The shape of the liquid storage 200 of the apparatus for measuring the volume of liquid of FIG. 2 may be a rectangular parallelepiped, and first corresponding faces to which a pair of metal plates for measuring first capacitance are attached, and second corresponding faces to which another pair of metal plates for measuring second capacitance may be disposed vertically, as illustrated in FIG. 2. However, such a shape is not required to measure the volume of liquid that remains in the liquid storage 200 by using capacitances of a plurality of channels. The pair of metal plates attached to internal faces of the liquid storage 200 of FIG. 2 corresponds to a parallel plate capacitor. There are various shapes of capacitors in addition to the parallel plate capacitor of FIG. 2 that may be used. For example, a metal plate 2241 attached to internal curved faces of a cylindrical liquid storage and a metal plate 2242 attached to external curved faces of a circular cylinder inside the liquid storage, as illustrated in FIG. 10B, may constitute a cylindrical capacitor that corresponds to a channel D. Metal plates 2251 and 2252 attached to each of top and bottom surfaces of the cylindrical liquid storage illustrated in FIG. 10B may constitute a parallel plate capacitor that corresponds to a channel E. Accordingly, it will be understood from the above-described embodiments by one of ordinary skill in the art that an apparatus for measuring the volume of liquid that remains in the liquid storage 200 can be designed by using shapes of capacitors other than the capacitor shapes illustrated in FIGS. 2 through 10.

According to the above embodiments, the volume of liquid stored in the liquid storage 200 may be calculated using a plurality of capacitances between several pairs of metal plates attached to the liquid storage 200 based on the current position of the liquid storage 200 so that the volume of liquid stored in the liquid storage 200 may be precisely measured in any of three positions of the liquid storage 200. The volume of liquid stored in the liquid storage 200 may be calculated by finding a combination of liquid volume values corresponding to the plurality of capacitances that are most appropriate to the current position of the liquid storage 200 so that the volume of liquid stored in the liquid storage 200 may be more precisely measured compared to a case where one capacitance is used. Furthermore, when the amount of liquid that remains in the liquid storage 200 is small, the volume of liquid stored in the liquid storage 200 may be more precisely measured. In addition, a weighting factor of a liquid volume value corresponding to a capacitance that is not affected or that is less affected by bubbles in the liquid storage 200 among the plurality of capacitances may be increased so that the remaining amount of liquid stored in the liquid storage 200 may be precisely measured without the effect of bubbles that may exist in the liquid storage 200 or with a minimum effect of bubbles.

In this way, in the above embodiments, the remaining amount of liquid stored in the liquid storage 200 may be precisely measured without being affected by bubbles in the liquid storage 200 or with the minimum effect of bubbles in any of the three positions of the liquid storage 200. The method and apparatus for measuring the volume of liquid may be very suitable for measuring the amount of fuel that remains in a portable fuel cell system in which there may be large changes in the position of the liquid storage due to actions of a user and in which a large number of bubbles may be generated due to replacement of a fuel cartridge.

The method of measuring the volume of liquid performed by the processor 320 may also be embodied as computer readable codes on a computer readable recording medium. The computer readable recording medium may be any data storage device that can store data that can be thereafter read by a computer system. Examples of the computer readable recording medium include read-only memory (ROM), random-access memory (RAM), CD-ROMs, magnetic tapes, floppy disks, optical data storage devices, etc.

By way of summation and review, fuel, water, air, and the like may be supplied to fuel cells so as to generate power by using fuel cell systems. When the amount of these materials that is supplied is not appropriate, fuel cells may not operate normally. In particular, when fuel to be supplied to a fuel cell system is exhausted, the fuel cell may not operate normally. Thus, the operation of a fuel cell system may be stopped before its fuel is exhausted. For this reason, research into measuring the amount of fuel that remains in fuel cell systems has been conducted. According to embodiments disclosed herein, methods and apparatuses are provided whereby a volume of liquid stored in a liquid storage may be measured accurately regardless of whether bubbles are present and regardless of the position in which the liquid storage is disposed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A method of measuring a volume of liquid, the method comprising:
receiving a first capacitance value representing a first capacitance between first metal plates attached to a liquid storage and a second capacitance value representing a second capacitance between second metal plates attached to the liquid storage;
obtaining a first liquid volume value corresponding to the first capacitance value and a second liquid volume value corresponding to the second capacitance value; and
calculating a volume of liquid that remains in the liquid storage by combining a plurality of liquid volume values including the first liquid volume value and the second liquid volume value.

2. The method as claimed in claim 1, wherein the calculating of the volume of liquid includes:
calculating a first weighting factor with respect to the first liquid volume value and a second weighting factor with respect to the second liquid volume value based on a current position of the liquid storage, and
calculating the volume of liquid by combining the plurality of liquid volume values including the first liquid volume value to which the calculated first weighting factor is applied and the second liquid volume value to which the second calculated weighting factor is applied.

3. The method as claimed in claim 2, wherein the calculating of the volume of liquid includes adding together the plurality of liquid volume values including the first liquid volume value to which the calculated first weighting factor is applied and the second liquid volume value to which the second calculated weighting factor is applied.

4. The method as claimed in claim 2, wherein the calculating of the volume of liquid includes calculating the current position of the liquid storage from a first gradient of the first metal plates having the first capacitance and a second gradient of the second metal plates having the second capacitance.

5. The method as claimed in claim 1, wherein the first metal plates having the first capacitance are attached to each of first corresponding faces of the liquid storage, and the second metal plates having the second capacitance are attached to each of second corresponding faces of the liquid storage.

6. The method as claimed in claim 5, wherein the calculating of the volume of liquid includes calculating a first weighting factor with respect to the first liquid volume value based on a gradient formed by the first metal plates attached to each of the first corresponding faces and calculating a second weighting factor with respect to the second liquid volume value based on a gradient formed by the second metal plates attached to each of the second corresponding faces.

7. The method as claimed in claim 1, wherein the first liquid volume value and the second liquid volume value are obtained based on a change in the first capacitance and the second capacitance due to a change in an amount of liquid that remains in the liquid storage.

8. The method as claimed in claim 7, wherein the first liquid volume value and the second liquid volume value are obtained from a database providing values representing changes in the first capacitance and the second capacitance due to changes in an amount of liquid that remains in the liquid storage.

9. The method as claimed in claim 7, wherein the first liquid volume value and the second liquid volume value are obtained from a function indicating changes in the first capacitance and the second capacitance due to changes in an amount of liquid that remains in the liquid storage.

10. A computer-readable recording medium having recorded thereon a program for executing a method of measuring a volume of liquid, the method comprising:
receiving a first capacitance value representing a first capacitance between first metal plates attached to a liquid storage and a second capacitance value representing a second capacitance between second metal plates attached to the liquid storage;
obtaining a first liquid volume value corresponding to the first capacitance value and a second liquid volume value corresponding to the second capacitance value; and
calculating a volume of liquid that remains in the liquid storage by combining a plurality of liquid volume values including the first liquid volume value and the second liquid volume value.

11. An apparatus for measuring a volume of liquid, the apparatus comprising:
a first pair of metal plates attached to a liquid storage for measurement of a first capacitance;
a second pair of metal plates attached to the liquid storage for measurement of a second capacitance; and
a processor that calculates a volume of liquid that remains in the liquid storage based on the first capacitance and the second capacitance.

12. The apparatus as claimed in claim 11, wherein:
the liquid storage includes a housing having an insulation property,
the first pair of metal plates for measurement of the first capacitance are attached to first corresponding faces among internal faces of the housing, and
the second pair of metal plates for measurement of the second capacitance are attached to second corresponding faces among the internal faces of the housing.

13. The apparatus as claimed in claim 12, wherein the first corresponding faces and the second corresponding faces are disposed vertically.

14. The apparatus as claimed in claim 12, wherein at least one of the first corresponding faces and the second corresponding faces are curved faces.

15. The apparatus as claimed in claim 12, wherein a third pair of metal plates are attached to the liquid storage for measurement of a third capacitance.

16. The apparatus as claimed in claim 11, wherein the liquid storage further comprises:
a housing having an insulation property, and
a pouch in which liquid is stored, the pouch being located in the housing, and
the pouch having elasticity.

17. The apparatus as claimed in claim 16, wherein a first surface of the pouch adjoins and is fixed to one metal plate among the first pair of metal plates and second pair of metal plates and a second surface of the pouch is not fixed to any of the metal plates among the first pair of metal plates and the second pair of metal plates.

18. The apparatus as claimed in claim 16, wherein a size of the pouch is greater than an internal size of the housing.

19. The apparatus as claimed in claim 11, further comprising a position sensor detecting a current position of the liquid storage.

20. The apparatus as claimed in claim 19, wherein the position sensor is attached to a face of the liquid storage and detects the current position of the liquid storage by detecting a gradient formed by the face to which the position sensor is attached with respect to a reference face.

21. The apparatus as claimed in claim 19, wherein the processor measures an amount of liquid that remains in the liquid storage by combining liquid volume values corresponding to the first capacitance and the second capacitance based on the current position of the liquid storage.

22. A fuel cell system, comprising:
a first pair of metal plates attached to a fuel storage for measurement of first capacitance;
a second pair of metal plates attached to the fuel storage for measurement of second capacitance; and
a controller that calculates a volume of fuel that remains in the fuel storage based on the first capacitance and the second capacitance.

23. The fuel cell system as claimed in claim 22, wherein:
the fuel storage includes a housing having an insulation property, the first pair of metal plates for measurement of the first capacitance are attached to first corresponding faces among internal faces of the housing, and
the second pair of metal plates for measurement of the second capacitance are attached to second corresponding faces among the internal faces of the housing.

24. The fuel cell system as claimed in claim 22, wherein:
the fuel storage includes:
a housing having an insulation property, and
a pouch in which fuel is stored, the pouch being located in the housing and having elasticity, and
part of a surface of the pouch adjoins part of the metal plates and is fixed to the part of the metal plates.

25. The fuel cell system as claimed in claim 22, further comprising a position sensor detecting a current position of the liquid storage, and wherein the controller measures an amount of fuel that remains in the fuel storage by combining fuel volume values corresponding to the first capacitance and the second capacitance based on the current position of the fuel storage.
